(19) United States
(12) Patent Application Publication
(10) Pub. No.: US 2026/0329356 A1
(43) Pub. Date: Oct. 22, 2026

(54) ELECTRONIC DEVICE AND HOUSING STRUCTURE INCLUDING ION FAN

(71) Applicant: COMPAL ELECTRONICS, INC., Taipei City (TW)

(72) Inventors: Han-Ming Wu, Taipei City (TW); Wen-Hsien Chin, Taipei City (TW); Chen-Cheng Wang, Taipei City (TW); Ching-Chung Chen, Taipei City (TW); Shi-Kuan Chen, Taipei City (TW)

(73) Assignee: COMPAL ELECTRONICS, INC., Taipei City (TW)

(21) Appl. No.: 19/641,551

(22) Filed: Apr. 8, 2026

Related U.S. Application Data
(60) Provisional application No. 63/790,748, filed on Apr. 18, 2025.
(60) Provisional application No. 63/806,019, filed on May 15, 2025.

(51) Int. Cl. G06F 1/20; G06F 1/16

(52) U.S. Cl. CPC G06F 1/203; G06F 1/1656

(57) ABSTRACT

An electronic device includes a first housing, a second housing mounted on the first housing, a carrier disposed between the first and second housings, and an ion fan disposed on the carrier. The first housing includes a bottom portion having an air inlet area and a side edge portion surrounding the bottom portion. The carrier includes a frame and a supporting base extending from the frame. The frame and the supporting base partially cover part of the bottom portion other than the air inlet area. The ion fan includes a driver disposed on the supporting base, a flow shroud disposed on the supporting base or the frame and having an air duct, an emitter electrode electrically coupled to the driver and disposed in the air duct, and a collector electrode disposed opposite to the emitter electrode in the air duct. A housing structure including an ion fan is also provided.

### CROSS-REFERENCE TO RELATED APPLICATION

This application claims the priority benefits of U.S. provisional application serial no. 63/790,748, filed on Apr. 18, 2025, and U.S. provisional application serial no. 63/806,019, filed on May 15, 2025. The entirety of each of the above-mentioned patent applications is hereby incorporated by reference herein and made a part of this specification.

### BACKGROUND

### TECHNICAL FIELD

The disclosure relates to an electronic device and a housing structure, and more particularly to an electronic device and a housing structure including an ion fan.

### DESCRIPTION OF RELATED ART

As the computing performance of central processing units and graphics processing units continues to improve, the thermal power dissipation generated during operation also increases significantly, resulting in a large amount of heat accumulating inside the chassis. Most current heat dissipation mechanisms adopt a combination of centrifugal fans, heat pipes, and heat dissipation fins to quickly dissipate heat to the outside by heat conduction and convection, so as to prevent the central processing units and the graphics processing units from overheating and causing performance degradation or thermal failure. However, under the design trend of pursuing extreme thinness and lightness for notebook computers, the thickness of centrifugal fans or axial fans has become a design bottleneck for further thinning of the chassis. Furthermore, as the chassis becomes thinner, such conventional fans must maintain high operational speeds to introduce sufficient heat dissipation airflow, thereby generating high-frequency noise.

### SUMMARY

The disclosure provides an electronic device and a housing structure including an ion fan, which can not only meet the design trend of thinness and lightness, but can also prevent the generation of high-frequency noise.

An electronic device according to an embodiment of the disclosure includes a first housing, a second housing, a carrier, and at least one ion fan. The first housing includes a bottom portion having an air inlet area and a side edge portion surrounding the bottom portion. The second housing is mounted on the first housing. The carrier is disposed between the first housing and the second housing, and includes a frame and at least one supporting base connected to the frame. The supporting base extends from the frame, and the frame and the supporting base partially cover a part of the bottom portion other than the air inlet area. The ion fan is disposed on the carrier and includes a driver, a flow shroud, an emitter electrode, and a collector electrode. The driver is disposed on the supporting base. The flow shroud is disposed on the supporting base or the frame and has an air duct. The emitter electrode is electrically coupled to the driver and is disposed in the air duct. The collector electrode is disposed opposite to the emitter electrode in the air duct.

A housing structure according to an embodiment of the disclosure includes a housing, a carrier, and at least one ion fan. The housing includes a bottom portion having an air inlet area and a side edge portion surrounding the bottom portion. The carrier includes a frame and at least one supporting base connected to the frame. The supporting base extends from the frame, and the frame and the supporting base partially cover a part of the bottom portion other than the air inlet area. The ion fan is disposed on the carrier and includes a driver, a flow shroud, an emitter electrode, and a collector electrode. The driver is disposed on the supporting base. The flow shroud is disposed on the supporting base or the frame and has an air duct. The emitter electrode is electrically coupled to the driver and is disposed in the air duct. The collector electrode is disposed opposite to the emitter electrode in the air duct.

Based on the above, in the electronic device and the housing structure of the disclosure, by the high degree of structural integration between the ion fan, the carrier, and the housing, the extreme thinning of the chassis thickness can be implemented. In addition, by using the ion fan to generate the ion flow inside the thinned chassis to drive the air to form the heat dissipation airflow, the high-frequency noise caused by the high-speed operation of the centrifugal fan can be effectively reduced.

In order for the features and advantages of the disclosure to be more comprehensible, the following specific embodiments are described in detail in conjunction with the drawings.

### BRIEF DESCRIPTION OF THE DRAWINGS

FIG. 1A is a schematic diagram of a housing structure according to an embodiment of the disclosure.

FIG. 1B is an exploded schematic diagram of the housing structure of FIG. 1A.

FIG. 1C is an exploded schematic diagram of a carrier and an ion fan of FIG. 1B.

FIG. 1D is a top schematic diagram of the housing structure of FIG. 1A.

FIG. 1E is an enlarged schematic diagram of a region 1E of FIG. 1D.

FIG. 2A is a schematic diagram of an electronic device according to an embodiment of the disclosure.

FIG. 2B is an exploded schematic diagram of the electronic device of FIG. 2A.

FIG. 2C is a schematic diagram of FIG. 2B with a second housing omitted.

### DESCRIPTION OF THE EMBODIMENTS

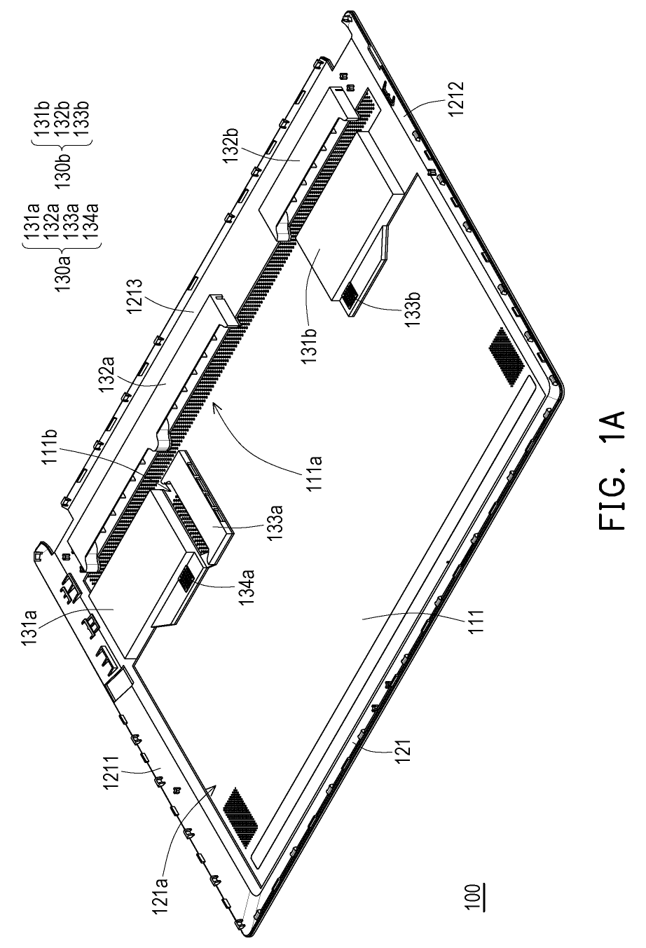

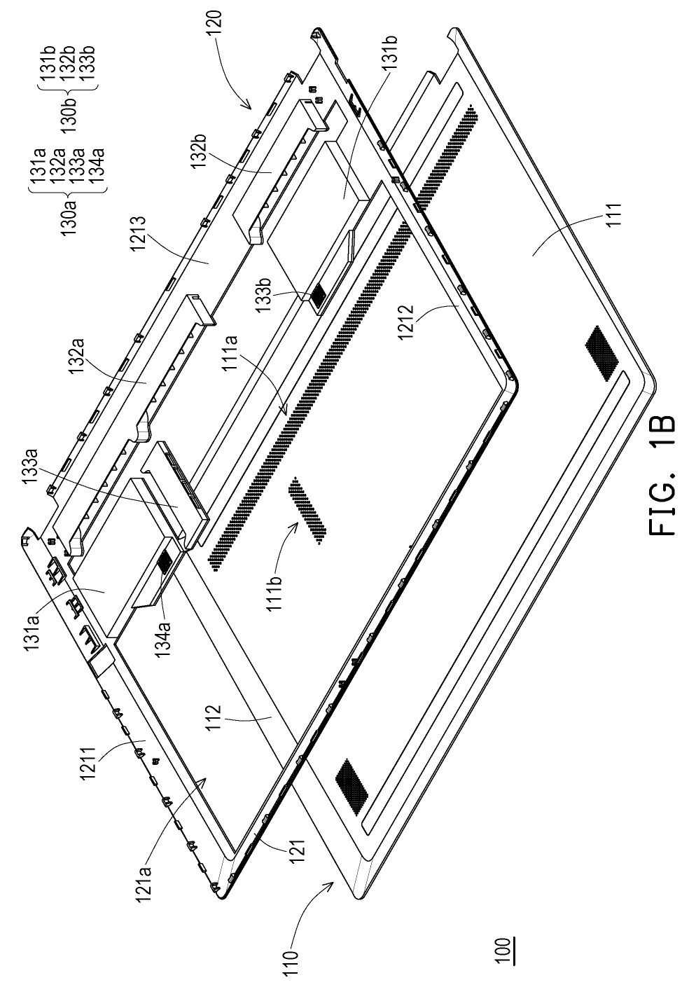

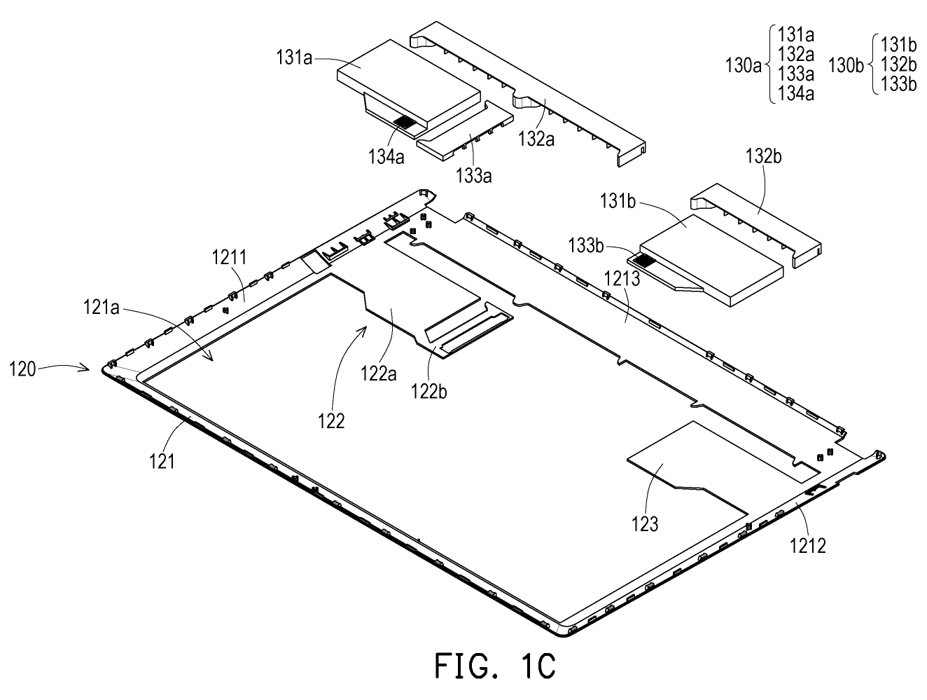

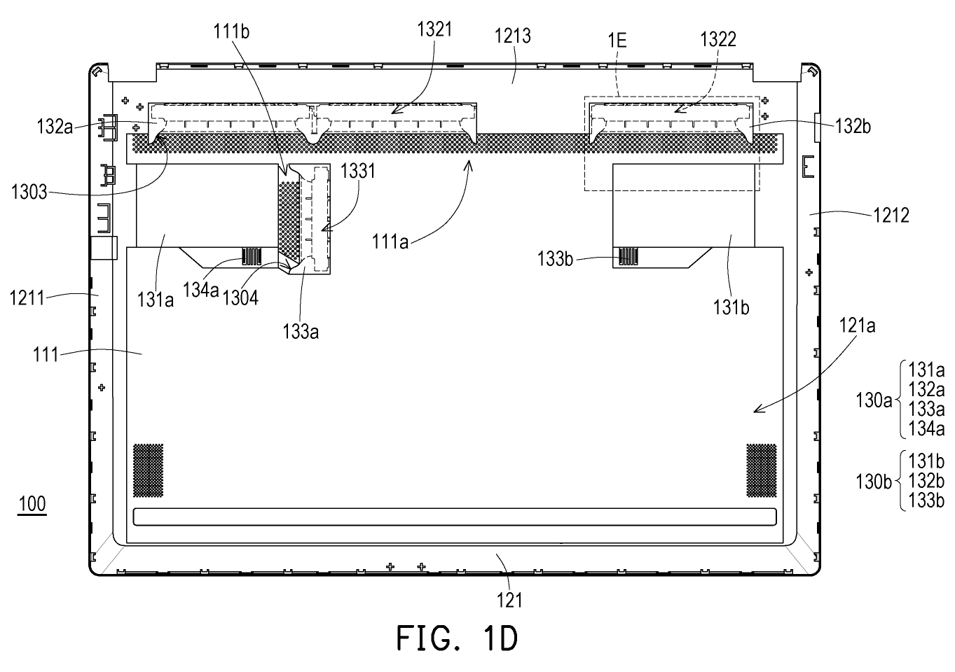

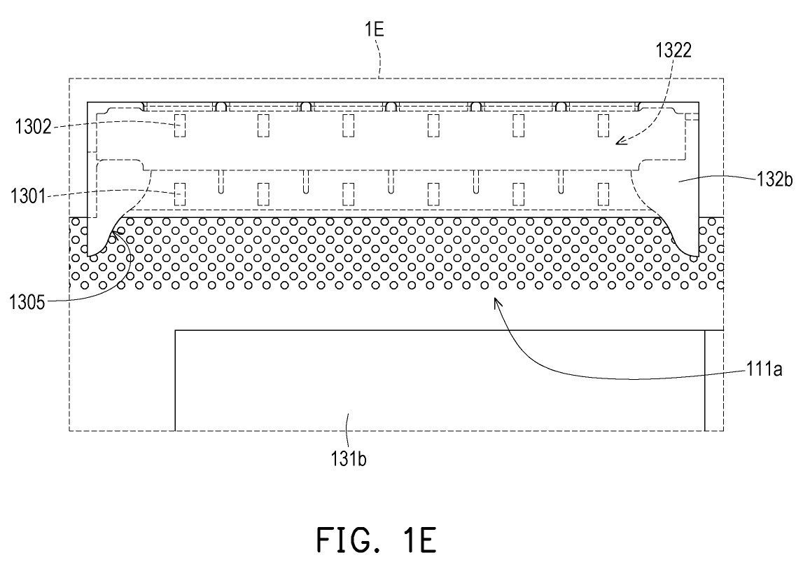

FIG. 1A is a schematic diagram of a housing structure according to an embodiment of the disclosure. FIG. 1B is an exploded schematic diagram of the housing structure of FIG. 1A. FIG. 1C is an exploded schematic diagram of a carrier and an ion fan of FIG. 1B. Please refer to FIG. 1A to FIG. 1C. In this embodiment, a housing structure 100 is part of a notebook computer or other similar electronic devices and includes a housing 110, a carrier 120, an ion fan 130a, and an ion fan 130b. The housing 110 may be a metal housing and includes a bottom portion 111 and a side edge portion 112 surrounding the bottom portion 111. The bottom portion 111 has an air inlet area 111aand an air inlet area 111b, and multiple air inlet holes penetrating the bottom portion 111 are distributed in the air inlet area 111a and the air inlet area 111b to introduce external cold air.

The carrier 120 may be an insulating carrier integrated onto the housing 110, such as being combined with the housing 110 by means of high-frequency welding, ultrasonic welding, adhesive bonding, anchoring, or insert molding. Referring to FIG. 1C, the carrier 120 includes a frame 121, a supporting base 122, and a supporting base 123, wherein the frame 121 is a hollow frame disposed corresponding to the side edge portion 112, and the supporting base 122 and the supporting base 123 are connected to an inner edge of the frame 121. In detail, the frame 121, the supporting base 122 and the supporting base 123 jointly define at least part of a hollow area 121a exposing the bottom portion 111, and the frame 121, the supporting base 122, and the supporting base 123 partially cover a part of the bottom portion 111 other than the air inlet area 111a and the air inlet area 111b. In other words, the supporting base 122 and the supporting base 123 are surrounded by the frame 121, and the air inlet area 111a and the air inlet area 111b fall within the hollow area 121a.

As shown in FIGS. 1B and 1C, the frame 121 includes at least two first frame segments 1211 and 1212 and a second frame segment 1213, wherein the two first frame segments 1211 and 1212 are disposed opposite to each other, and the second frame segment 1213 is connected between the two first frame segments 1211 and 1212. The supporting base 122 is connected to the first frame segment 1211 and extends from the first frame segment 1211 toward the direction of the first frame segment 1212. The supporting base 123 is connected to the first frame segment 1212 and extends from the first frame segment 1212 toward the direction of the first frame segment 1211.

The supporting base 122 and the supporting base 123 are located on one side of the second frame segment 1213 and are spaced apart from the second frame segment 1213. The air inlet area 111a is roughly distributed from the first frame segment 1211 toward the first frame segment 1212, wherein a part of the air inlet area 111a is located between the supporting base 122 and the second frame segment 1213, and another part of the air inlet area 111a is located between the supporting base 123 and the second frame segment 1213.

In this embodiment, the supporting base 122 includes a first supporting portion 122a connected to the first frame segment 1211 and a second supporting portion 122b connected to the first supporting portion 122a, and the second supporting portion 122b is closer to the supporting base 123 than the first supporting portion 122a. For example, the second supporting portion 122b is connected to a side of the first supporting portion 122a away from the second frame segment 1213 to form a notch facing the second frame segment 1213 between the first supporting portion 122a and the second supporting portion 122b, so as to expose the air inlet area 111b. In other words, the air inlet area 111b is located between the first supporting portion 122a and the second supporting portion 122b.

FIG. 1D is a top schematic diagram of the housing structure of FIG. 1A. FIG. 1E is an enlarged schematic diagram of a region 1E of FIG. 1D. Please refer to FIG. 1A to FIG. 1D. The ion fan 130a and the ion fan 130b are integrated onto the carrier 120, such as being combined with the carrier 120 by means of high-frequency welding, ultrasonic welding, adhesive bonding, anchoring, or insert molding. The ion fan 130a includes a driver 131a disposed on the first supporting portion 122a of the supporting base 122, a flow shroud 132a disposed on the second frame segment 1213, and a flow shroud 133a disposed on the second supporting portion 122b of the supporting base 122. In addition, the ion fan 130bincludes a driver 131b disposed on the supporting base 123 and a flow shroud 132b disposed on the second frame segment 1213.

As shown in FIG. 1D, the flow shroud 132a has an air duct 1321 corresponding to the air inlet area 111a to guide an airflow or determine a direction thereof. The flow shroud 133a has an air duct 1331 corresponding to the air inlet area 111b to guide an airflow or determine a direction thereof. In addition, the flow shroud 132b has an air duct 1322 corresponding to the air inlet area 111a to guide an airflow or determine a direction thereof. Each ion fan has the same or similar electrode configuration in the air duct of the flow shroud. The following example illustrates the ion fan 130b.

As shown in FIG. 1E, the ion fan 130b is provided with an emitter electrode 1301 and a collector electrode 1302 opposite to each other in the air duct 1322 of the flow shroud 132b, wherein the emitter electrode 1301 is electrically coupled to the driver 131b, and the emitter electrode 1301 is located between the air inlet area 111a and the collector electrode 1302. Furthermore, the emitter electrode 1301 is arranged at an inlet of the air duct 1322 near the air inlet area 111a, and the collector electrode 1302 is arranged at an outlet of the air duct 1322 away from the air inlet area 111a. Since a conventional fan draws air via the operation of fan blades, the conventional fan needs to be configured to cover an air inlet area. For example, an orthographic projection of the conventional fan on a bottom portion of a housing overlaps with the air inlet area. In contrast, the configuration of the ion fan 130b does not need to overlap with the air inlet area 111a. For example, an orthographic projection of the ion fan 130b on the bottom portion 111 of the housing 110 does not overlap with the air inlet area 111a.

A voltage is applied to the emitter electrode 1301 by the driver 131b, and the emitter electrode 1301 ionizes air from the air inlet area 111a. Driven by an electric field between the emitter electrode 1301 and the collector electrode 1302, air ions move from the emitter electrode 1301 toward the collector electrode 1302 to form an ion flow, which in turn drives the air to form an airflow. This may also be understood as that the movement direction of the ion flow does not directly correspond to the air inlet area 111a.

Similarly, the driver 131a may apply a voltage to an emitter electrode in the flow shroud 132a to ionize air from the air inlet area 111a, and apply a voltage to an emitter electrode in the flow shroud 133a to ionize air from the air inlet area 111b. In the flow shroud 132a, air ions move from the emitter electrode toward a collector electrode to form an ion flow, which in turn drives the air to form an airflow. In the flow shroud 133a, air ions move from the emitter electrode toward a collector electrode to form an ion flow, which in turn drives the air to form an airflow.

For example, the flow direction of the airflow in the flow shroud 132a is parallel to the flow direction of the airflow in the flow shroud 132b and is perpendicular to the flow direction of the airflow in the flow shroud 133a.

It should be noted that the housing 110 is made of a metal material. In order to prevent the housing 110 from interfering with a high-voltage electric field generated by the driver 131a, this embodiment adopts the carrier 120 made of an insulating material to support the driver 131a, so as to isolate the driver 131a from the housing 110, preventing metal parts from weakening the ion flow or causing potential short circuit risk of electronic elements. On the other hand, the metal exposed from the hollow area 121a can enhance the overall heat dissipation effect using the excellent thermal conductivity thereof. Furthermore, the frame 121 and the supporting base 122 made of the insulating material partially cover the part of the bottom portion 111 made of the metal material other than the air inlet area 111a and the air inlet area 111b, which may both prevent the metal parts from weakening the ion flow or causing potential short circuit risk of the electronic elements, and enhance the overall heat dissipation effect.

As shown in FIG. 1D, the flow shroud 132a has a flow surface 1303 extending toward the driver 131a or the air inlet area 111a at the inlet of the air duct 1321 near the air inlet area 111a to guide the airflow into the air duct 1321. The flow shroud 133a has a flow surface 1304 extending toward the driver 131a or the air inlet area 111b at the inlet of the air duct 1331 near the air inlet area 111b to guide the airflow into the air duct 1331. In addition, the flow shroud 132b has a flow surface 1305 extending toward the driver 131b or the air inlet area 111a at the inlet of the air duct 1322 near the air inlet area 111a to guide the airflow into the air duct 1322.

It should be noted that the number of ion fans and the corresponding supporting bases in the disclosure is not limited to the number shown in the drawings or the foregoing description. The actual number of ion fans may be disposed according to the space of the housing structure 100 or the location of a heat source.

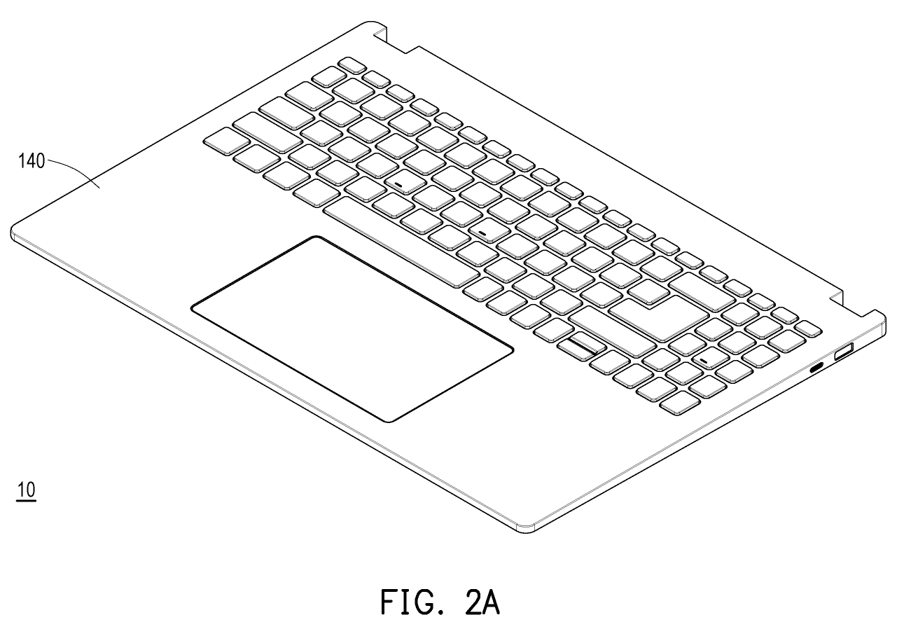

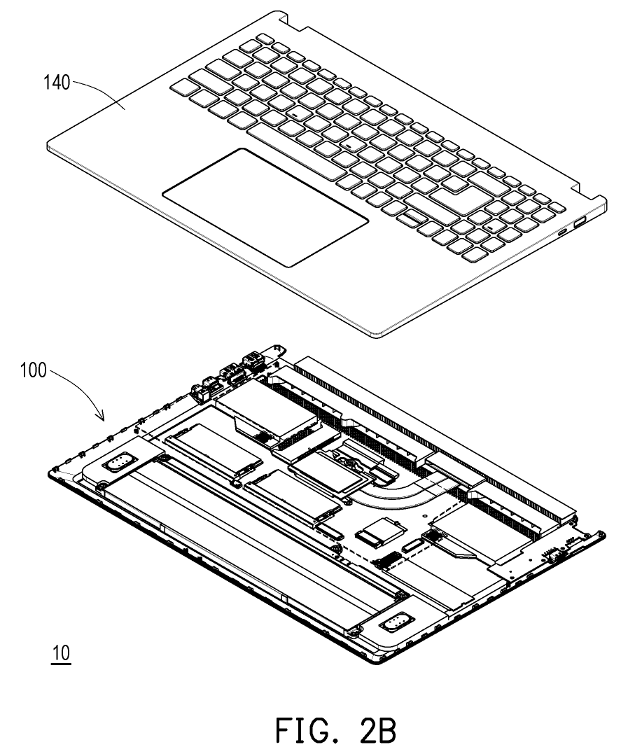

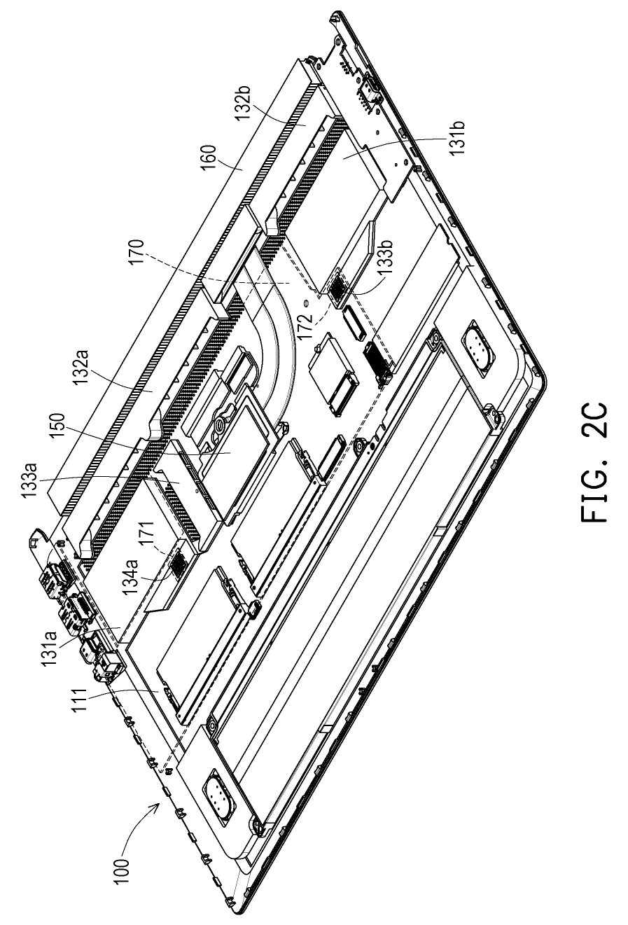

FIG. 2A is a schematic diagram of an electronic device according to an embodiment of the disclosure. FIG. 2B is an exploded schematic diagram of the electronic device of FIG. 2A. FIG. 2C is a schematic diagram of FIG. 2B with a second housing omitted. Please refer to FIGS. 1A, 1B, 2B and 2C. The electronic device 10 may be the chassis of a notebook computer and is composed of at least a housing 140 and the housing structure 100. In detail, the housing 110 in the housing structure 100 may be used as a first housing, and the housing 140 mounted on the housing 110 may be used as a second housing. Furthermore, the carrier 120, the ion fan 130a, and the ion fan 130b are disposed between the housing 110 and the housing 140, or in other words, the carrier 120, the ion fan 130a, and the ion fan 130b are disposed in an internal space formed by the housing 110 and the housing 140.

By the high degree of structural integration between the ion fan 130a, the ion fan 130b, carrier 120, and the housing 110, the extreme thinning of the chassis thickness can be implemented. In addition, by using the ion fan 130a and the ion fan 130b to generate the ion flow inside the thinned chassis to drive the air to form a heat dissipation airflow, the high-frequency noise caused by the high-speed operation of the centrifugal fan can be effectively reduced.

As shown in FIGS. 1A-1C and 2C, the electronic device 10 is provided with a heat source 150, a heat dissipation fin 160, and a circuit board 170 between the housing 110 and the housing 140 or in the internal space formed by the housing 110 and the housing 140. The heat source 150 may be a central processing unit or a graphics processing unit and is disposed on a side of the circuit board 170 facing the bottom portion 111 of the housing 110. The flow shroud 133a of the ion fan 130a is located between the driver 131a and the heat source 150, and the air from the air inlet area 111b may form an airflow flowing toward the heat source 150 in the flow shroud 133a to exchange heat with the heat source 150, so as to achieve heat dissipation.

The heat dissipation fin 160 is disposed corresponding to the second frame segment 1213, wherein the flow shroud 132a of the ion fan 130a is located between the driver 131a and the heat dissipation fin 160, and the flow shroud 132b of the ion fan 130b is located between the driver 131b and the heat dissipation fin 160. The air from the air inlet area 111a may form an airflow flowing between the heat dissipation fins 160 in the flow shroud 132a and the flow shroud 132b to exchange heat with the heat dissipation fins 160, so as to achieve heat dissipation.

A side of the circuit board 170 facing the bottom portion 111 of the housing 110 is provided with two power supply connectors 171 and 172, wherein the ion fan 130a is provided with a power receiving connector 134a on a side of the driver 131a, and the ion fan 130b is provided with a power receiving connector 133b on a side of the driver 131b. The power receiving connector 134a is disposed on the first supporting portion 122a of the supporting base 122, and the power receiving connector 133b is disposed on the supporting base 123.

When the circuit board 170 is mounted and positioned in the housing 110, the power supply connector 171 synchronously makes electrical contact with the power receiving connector 134a, and the power supply connector 172 synchronously makes electrical contact with the power receiving connector 133b, so as to establish electrical connections between the ion fans 130a and 130b and a power supply. In other words, by removing or mounting the circuit board 170, the electrical connections between the ion fans 130a and 130b and the power supply can be synchronously established or disconnected, which not only helps to eliminate the tedious steps of removing or mounting the wiring, but also saves the space required for configuring the wiring, so as to optimize the use of the internal space of the chassis.

As shown in FIG. 2C, the power supply connector 171 is in electrical contact with the power receiving connector 134a, and the driver 131a may be electrically coupled to the power supply connector 171 through the power receiving connector 134a to receive voltage and current from the power source. In addition, the power supply connector 172 is in electrical contact with the power receiving connector 133b, and the driver 131b may be electrically coupled to the power supply connector 172 through the power receiving connector 133b to receive voltage and current from the power source. For example, the power receiving connector and the power supply connector may adopt a spring conductive structure, a pogo pin conductive structure, or other conductive structures that adopt mechanical pressing to achieve electrical conduction, so as to implement quick removing or mounting.

In summary, in the electronic device and the housing structure of the disclosure, by the high degree of structural integration between the ion fan, the carrier, and the housing, the extreme thinning of the chassis thickness can be implemented. In addition, by using the ion fan to generate the ion flow inside the thinned chassis to drive the air to form the heat dissipation airflow, the high-frequency noise caused by the high-speed operation of the centrifugal fan can be effectively reduced.

On the other hand, the ion fan is provided with the power receiving connector on a side of the driver, and the circuit board is correspondingly provided with the power supply connector. When the circuit board is mounted and positioned in the housing, the power supply connector synchronously makes electrical contact with the power receiving connector, so as to establish electrical connection between the ion fan and the power supply. In other words, by removing or mounting the circuit board, the electrical connection between the ion fan and the power supply can be synchronously established or disconnected, which not only helps to eliminate the tedious steps of removing or mounting the wiring, but also saves the space required for configuring the wiring, so as to optimize the use of the internal space of the chassis.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An electronic device, comprising:
a first housing, comprising a bottom portion having an air inlet area and a side edge portion surrounding that bottom portion;
a second housing, mounted on the first housing;
a carrier, disposed between the first housing and the second housing, and comprising a frame and at least one supporting base connected to the frame, wherein the at least one supporting base extends from the frame, and the frame and the supporting base partially cover a part of the bottom portion other than the air inlet area; and
at least one ion fan, disposed on the carrier, wherein the at least one ion fan comprises:
a driver, disposed on the at least one supporting base;
a flow shroud, disposed on the at least one supporting base or the frame and having an air duct;
an emitter electrode, electrically coupled to the driver and disposed in the air duct; and
a collector electrode, disposed opposite to the emitter electrode in the air duct.

2. The electronic device according to claim 1, wherein the air inlet area is located between the at least one supporting base and the frame.

3. The electronic device according to claim 1, wherein the emitter electrode is located between the air inlet area and the collector electrode.

4. The electronic device according to claim 1, wherein the frame comprises a first frame segment and a second frame segment connected to the first frame segment, the at least one supporting base is connected to the first frame segment, the flow shroud is disposed on the second frame segment, and the air inlet area is located between the at least one supporting base and the second frame segment.

5. The electronic device according to claim 4, further comprising:
a heat dissipation fin, disposed between the first housing and the second housing corresponding to the second frame segment, wherein the flow shroud is located between the driver and the heat dissipation fin.

6. The electronic device according to claim 1, wherein the at least one supporting base comprises a first supporting portion connected to the frame and a second supporting portion connected to the first supporting portion, the driver is disposed on the first supporting portion, the flow shroud is disposed on the second supporting portion, and the air inlet area is located between the first supporting portion and the second supporting portion.

7. The electronic device according to claim 6, further comprising:
a heat source, disposed between the first housing and the second housing, wherein the flow shroud is located between the driver and the heat source.

8. The electronic device according to claim 1, further comprising:
a circuit board, disposed between the first housing and the second housing, and provided with a power supply connector on a side facing the bottom portion of the first housing, wherein the at least one ion fan further comprises a power receiving connector disposed on the at least one supporting base, the power receiving connector is located on a side of the driver, the power supply connector is in electrical contact with the power receiving connector, and the driver is electrically coupled to the power supply connector through the power receiving connector.

9. The electronic device according to claim 1, wherein the flow shroud further has a flow surface extending from the air duct toward the driver or the air inlet area.

10. The electronic device according to claim 1, wherein the first housing is a metal housing and the carrier is an insulating carrier.

11. A housing structure comprising an ion fan, comprising:
a housing, comprising a bottom portion having an air inlet area and a side edge portion surrounding the bottom portion;
a carrier, comprising a frame and at least one supporting base connected to the frame, wherein the at least one supporting base extends from the frame, and the frame and the supporting base partially cover a part of the bottom portion other than the air inlet area; and
at least one ion fan, disposed on the carrier, wherein the at least one ion fan comprises:
a driver, disposed on the at least one supporting base;
a flow shroud, disposed on the at least one supporting base or the frame and having an air duct;
an emitter electrode, electrically coupled to the driver and disposed in the air duct; and
a collector electrode, disposed opposite to the emitter electrode in the air duct.

12. The housing structure comprising the ion fan according to claim 11, wherein the air inlet area is located between the at least one supporting base and the frame.

13. The housing structure comprising the ion fan according to claim 11, wherein the emitter electrode is located between the air inlet area and the collector electrode.

14. The housing structure comprising the ion fan according to claim 11, wherein the frame comprises a first frame segment and a second frame segment connected to the first frame segment, the at least one supporting base is connected to the first frame segment, the flow shroud is disposed on the second frame segment, and the air inlet area is located between the at least one supporting base and the second frame segment.

15. The housing structure comprising the ion fan according to claim 11, wherein the at least one supporting base comprises a first supporting portion connected to the frame and a second supporting portion connected to the first supporting portion, the driver is disposed on the first supporting portion, the flow shroud is disposed on the second supporting portion, and the air inlet area is located between the first supporting portion and the second supporting portion.

16. The housing structure comprising the ion fan according to claim 11, wherein the at least one ion fan further comprises a power receiving connector disposed on the at least one supporting base, the power receiving connector is located on a side of the driver, and the driver is adapted to be electrically coupled to the power supply connector through the power receiving connector.

17. The housing structure comprising the ion fan according to claim 11, wherein the flow shroud further has a flow surface extending from the air duct toward the driver or the air inlet area.

18. The housing structure comprising the ion fan according to claim 11, wherein the housing is a metal housing and the carrier is an insulating carrier.
